(19) United States
(12) Patent Application Publication
(10) Pub. No.: US 2006/0071948 A1
(43) Pub. Date: Apr. 6, 2006

(54) 3D font-engine

(76) Inventor: Chris Hemmings, Hong Kong (HK)

Correspondence Address: JACOBSON HOLMAN PLLC, 400 SEVENTH STREET N.W., SUITE 600, WASHINGTON, DC, 20004, US

(21) Appl. No.: 11/190,061

(22) Filed: Jul. 27, 2005

Related U.S. Application Data
(63) Continuation of application No. 10/660,459, filed on Sep. 5, 2003, now abandoned.

(51) Int. Cl. G09G 5/00

(52) U.S. Cl. 345/649

(57) ABSTRACT

This invention relates to a 3-dimensional font-engine for redrawing characters onto a display screen to represent characters on a page. A user may continuously change orientation with respect to that page in 3-dimensional space and the characters themselves are rotated and redrawn to the display means after each change of orientation. The text layout on the page is not considered as a single image but instead the basic font information in terms of characteristic control points defining the curves of the characters are rotated prior to the image being redrawn to the display screen.

### FIELD OF THE INVENTION

This invention relates to a 3D font-engine suitable for presenting fonts in a 3D environment that may be viewed on a display means irrespective of the orientation of the publication on which the fonts may be presented in the 3-dimensional environment.

### BACKGROUND TO THE INVENTION

In today's environment, more and more information is being provided in the form of electronic publications on computer screens or similar. This includes documents provided in the form of word processing documents, publications presented through specialized applications such as Adobe Acrobat and the wide variety of documents available over the Internet presented to a user through the Internet browser.

In recent years, greater work has gone into producing 3-dimensional environment such as virtual reality environments in which a user may move around or with respect to the environment and view the environment from ever changing orientations.

In the 2-dimensional environment, fonts typically used for documents are generally held as database files called up by various applications to define the manner in which the particular character will appear on the screen. These are suitable for 2-dimensional environments whereby the characters of the font are defined in terms of a series of characteristic points that define the lines of the font. However, these fonts are intended for display on a 2-dimensional screen and presented flat on by drawing the character from the database file. Further, such characters are normally drawn such that they start and end on particular pixels on a display screen and do not start or end mid pixel which may dilute the clarity of the character particularly with smaller font sizes.

Once such characters are used in the display of a 3-dimensional image, the orientation on which such characters may be viewed has changed and the size of the character is progressively changing due to the user's virtual distance from the character. The characters as traditionally provided will no longer necessarily start or end on pixel boundaries.

For this reason, current technologies are not suitable or economic or do not retain sufficient clarity when trying to present text on a page of a publication or similar when viewed in a 3-dimensional environment, In the case of fonts displayed on computer screens run by Microsoft Windows, the Windows interface itself includes some tools for the manipulation of fonts. Although Windows does allow some rotation of a font character, it does offer true 3D rotation. The Windows package also provides a mechanism for the shearing of characters such as may be required in the presentation of italic characters. In some font sets, the original designer may have specifically provided an additional italic or bold font set. In others, a package like Windows is able to simulate that by providing some manipulation of the characters in the font set. However, this manipulation is limited and does not allow for rotation of the characters over three simultaneous axes as would be necessary in a 3-dimensional environment. Furthermore, the Windows package redraws the characters to the nearest pixel without any form of anti-aliasing of the lines drawn. Therefore, particularly on smaller fonts, close examination of the character on the screen can actually see lines of the character step from one pixel to another. Once in a 3-dimensional environment, these problems simply become more highlighted.

The manner in which text is manipulated in 3D environments currently is usually in the form of writing that may appear in games or other applications whereby the text forms part of the overall bitmap image. Although the image itself may be rotated, information is lost in the transformation and this loss of information can be particularly disruptive to text characters forming part of the overall image.

### OBJECT OF THE INVENTION

It is an object of the present invention to provide a font-engine that allows for the presentation of text on an electronic publication that may be viewed from different orientations while trying to maintain much of the clarity of the original font. As a minimum, it is an object of the present invention to provide a font-engine suitable for this purpose that provides the public with a useful choice.

### SUMMARY OF THE INVENTION

Accordingly, in the first aspect, the invention may broadly be said to consist in a method of producing an image on a display means corresponding to a font character rotated in a three dimensional environment comprising:
detecting a request from a user for the display of a character on at a particular orientation;
obtaining data on the character in terms of defining control points for the drawing of the character in a two dimensional environment;
rotating the defining control points to the orientation in three dimensional space; and
translating the points to the two dimensional environment of the display means and redrawing the character.

Preferably said defining character control points include Bezier curve control points for drawing the outline of the character.

Preferably said character is defined including quadratic Bezier control points for curves of the character in the data and these are sub-divided to points suitable for use with a cubic Bezier solution.

Preferably said character is redrawn to an enlarged grid in memory to determine the correct shade of pixels around at least a portion of the perimeter of the character.

Preferably a plurality of said font characters are provided in the form of a page of text and the image produced on the display means corresponds to the page of text rotated to a new orientation in a three dimensional environment.

Preferably said defining character control points are assigned an initial z axis value of zero when the data is supplied on the characters suitable for being drawn in a two dimensional environment and rotated with reference to a point of rotation to alter the z axis value if desired in the new orientation.

Accordingly, in a second aspect, the invention may broadly be said to consist in a method of displaying a page to text on a display means at a new orientation corresponding to movement of the page of text in a three dimensional environment comprising the steps of:
laying out the text in a two dimensional environment in terms of control points for the drawing of each character;
rotating all of the control points to the new orientation defined by the three dimensional environment; and
redrawing the text on the page at the new orientation.

Accordingly, in a third aspect the invention may broadly be said to consist in a computer readable medium encoded with a computer program to provide a method of producing an image on a display means corresponding to a font character rotated in a three dimensional environment comprising:
detecting a request from a user for the display of a character on at a particular orientation;
obtaining data on the character in terms of defining control points for the drawing of the character in a two dimensional environment;
rotating the defining control points to the orientation in three dimensional space; and
translating the points to the two dimensional environment of the display means and redrawing the character.

Accordingly, in a third aspect the invention may broadly be said to consist in a method of displaying a page to text on a display means at a new orientation corresponding to movement of the page of text in a three dimensional environment comprising the steps of:
laying out the text in a two dimensional environment in terms of control points for the drawing of each character;
rotating all of the control points to the new orientation defined by the three dimensional environment; and
redrawing the text on the page at the new orientation.

### BRIEF DESCRIPTION OF THE DRAWINGS

Preferred embodiments of the invention will now be described with reference to the following drawings in which:

FIG. 1 shows an image of fonts as may be presented on a typical prior art document;

FIG. 2 shows an image of fonts as they may need to be presented once rotated in a 3-dimensional environment;

FIG. 3 shows the typical construction of a character utilizing a series of curves;

FIG. 4A shows a yet further character and its characteristic control points;

FIG. 4B shows the character of FIG. 4A once rotated in a 3-dimensional environment;

FIG. 5 shows an enlarged grid showing the manner in which a curve through a partial pixel may be represented;

FIG. 6A shows a curve of a partial character defined by a quadratic bezier curve;

FIG. 6B shows the division of the quadratic bezier curve into a cubic bezier curve for the same portion of a character;

FIG. 7A shows a character as normally presented in a 2-dimensional environment;

FIG. 7B shows the character of FIG. 7A once rotated in a 3-dimensional environment and translated back to a 2-dimensional display screen; and

FIG. 8 is a flowchart outlining the principal steps of a program for performing an embodiment of the invention.

### DETAILED DESCRIPTION OF PREFERRED EMBODIMENTS

The present invention relates to a computer program or application suitable for being run on a computerized hardware to manipulate characters forming text in a 3-dimensional environment. In general, this will be described with reference to an electronic publication such as a multi-page publication carrying a significant amount of body text as this is where the advantages may be most apparent. Regardless, it will be appreciated that the invention applies whenever characters, whether English or any other language, are presented in a simulated 3D environment that is then viewed on a 2-dimensional personal computer monitor, virtual reality goggles or other display means.

It will be appreciated that when an electronic publication such as a book is simulated in a 3-dimensional environment, the publication itself can be provided as part of an overall image file such as a bitmap image and manipulated to the orientation of the user. However, this may significantly detract from the quality of the text.

If reading an electronic publication in a 3-dimensional environment with, for example, virtual reality goggles, it can be anticipated that the orientation of the user with respect to the publication will change, especially if it is intended to directly simulate real life. When reading a publication such as a newspaper normally, a reader will typically turn their head to scan the pages, perhaps move their head closer or further away to read different portions of the documents and generally consider the document from a variety of different angles as part of the normal reading motion. Existing electronic publications always provide the information flat on a 2-dimensional screen and the reading experience is somewhat different. The present invention seeks to provide a font engine or application to manipulate characters in a 3-dimensional environment while trying to improve the quality of the text shown to simulate the quality of printed text as opposed to that presented in a computer environment where the resolution of the screen itself can detract from print quality, particularly should that print be rotated and lose information as the image shifts.

It should also be noted that although the present invention is particularly directed to fonts for character sets to represent printed matter, aspects of the technology can equally be utilized on other defined images.

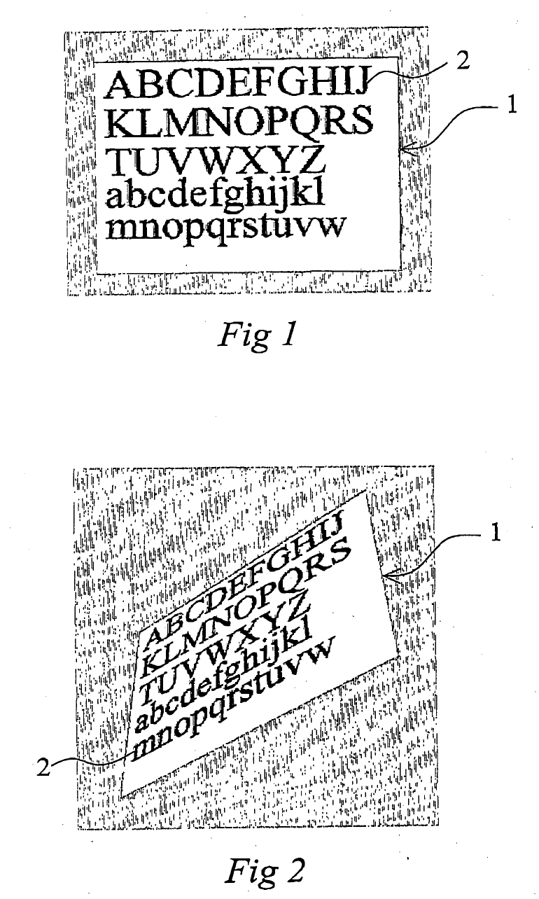

Referring to FIG. 1, an example of a typical page of a publication 1 is shown carrying a plurality of characters 2. For the present example shown in FIG. 1, the majority of a typical English language character set is shown in a font that defines the manner in which each of the characters are presented.

Referring to FIG. 2, the orientation of the same publication 1 has been changed and it can be seen that the characters 2 are now presented at a variety of different angles that will affect such things as line widths, sizes of the characters and numerous other aspects.

A preferred embodiment of the invention will be described which has been constructed to run on personal computers operating in a Windows environment. To simplify some aspects of the implementation of the program, some functions may be put out to Windows subroutines that already suitably accomplish specific processes. For example, once the font has been reconstructed and is intended to be redisplayed, Windows may attend to the actual redrawing of the character on the screen. For this reason, throughout the description, there may be specific mention made of adaptations to suit the Windows environment. It should be noted that this does not detract from the generality of the description that is intended to describe a system able to operate in a wide variety of systems. Furthermore, a computer program and application intended to implement this preferred embodiment is preferable constructed in assembly language due to the large number of calculations necessary to attend to handling a large amount of text. Assembly language is able to manipulate numbers through the use of registers on the processors rather than always returning to memory through the memory bus and, in circumstances such as this, can provide considerable advantages in terms of speed and hence performance. Again, the broader aspects of this technology are not restricted to assembly language coded applications and indeed the technology as a whole may be written in higher-level languages if desired.

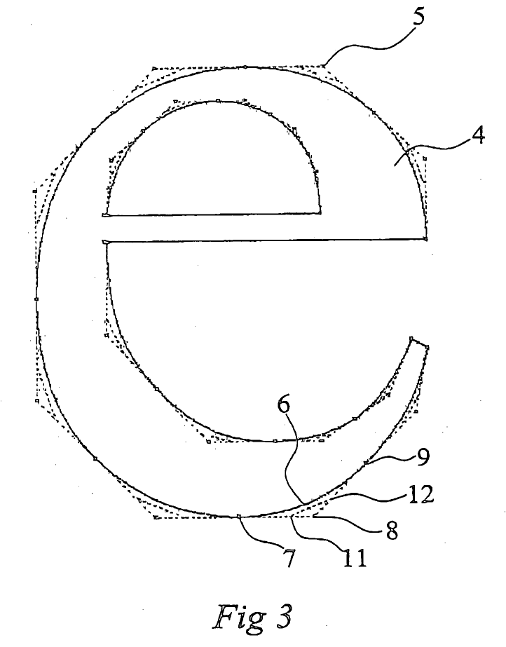

To understand the rotation of font characters, it is first necessary to review how fonts themselves are constructed FIG. 3 displays a typical character 3 in the form of the outline of the lower case character “e” as it may be defined in a typical font file. The font file itself contains a plurality of bezier curve control points 5 that define the curves to construct the outline of the character.

The advantage of using bezier curves to define characters in a font file is that bezier curve control points are scalable and translatable so that the position of the control points can be expanded or contracted to alter the size of the character and the curve that the control points define will accurately expand and contract to provide the same character.

Another feature of bezier control points is that they may also be rotated in 3-dimensional space and the curve that they originally defined on a 2-dimensional plane is still accurate on the rotated plane on which the character now resides.

Referring to FIG. 3, the curved portion 6 near the base of the character can be looked at in isolation. This portion of the curve is defined by 3 bezier control points being control points 7, 8 and 9. These points characterize the curve 6 and when rotated in 3-dimensional space onto a new plane, plotting the curve 6 with the bezier function provides the curve on the rotated plane.

That the curve 6 is defined by a start point 7, and in point 9 and a single control point in the middle 8 as is symptomatic of a quadratic bezier curve. As will be explained subsequently, the preferred embodiment of this invention prefers to utilize a cubic bezier curve function and, therefore, the bezier curve 6 is then defined by four bezier control points with points 11 and 12 being used in substitution of point 8. To find points 11 and 12, a standard function to define a quadratic bezier curve into a cubic bezier curve can be utilized.

As shown in FIG. 3, points 11 and 12 can be found by finding ⅔rds of the distance between points 7 and 8 to define point 11 and ⅔rds of the distance from point 9 to point 8 to define point 12. Most font files are defined in terms of quadratic bezier curves although it will be appreciated that any font, character or image already defined in terms of a cubic bezier curve requires no such manipulation. Furthermore, it should be noted that the use of the cubic curve is merely an advantageous result due to the preferred embodiment being designed to run on Windows. In the Windows operating system, a function already exists to fill within outlines to create a solid black character inside the lines defining the font character as shown in FIG. 3. This particular subroutine in Windows utilizes cubic bezier curve inputs and, therefore, the preferred embodiment of this invention utilizes that function rather than attempting to encode its own routine for this purpose. It will be appreciated that such a routine already exists in Windows and can be simulated in other languages or specially written for an application using a font engine in accordance with this invention.

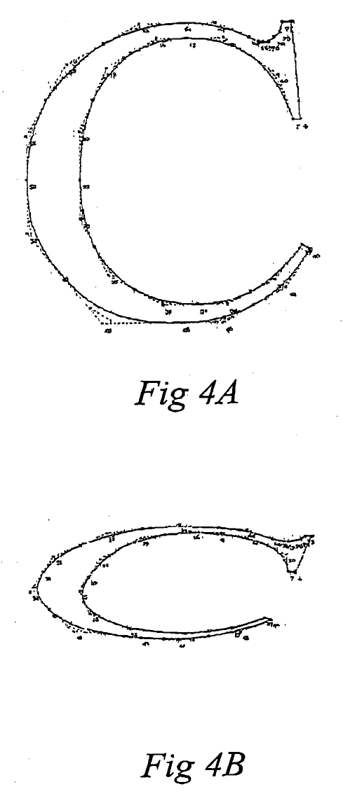

Referring to FIGS. 4A and 4B, a typical character C is shown In the case of the character C, there are in excess of 70 separate control points to define the curves of this particular character in this particular font style. This relates simply to the number of points for the character as defined with quadratic bezier curves. It will be appreciated that a significantly larger number of points exist if it is subdivided to be defined in terms of cubic bezier curves.

Once the bezier curve control points are rotated in 3-dimensional space, the curves of those points define continue to represent the letter C on the rotated plane as shown in FIG. 4B.

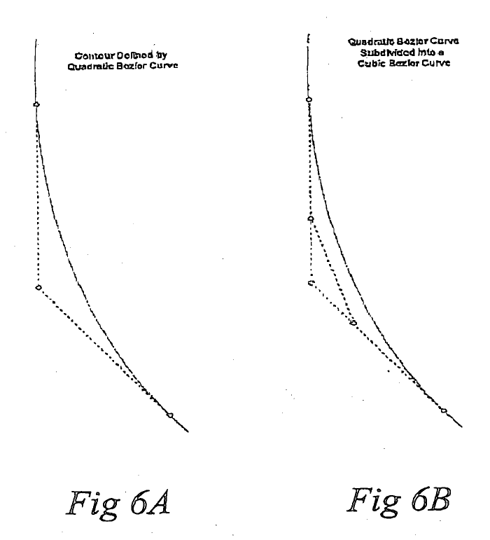

Manipulation of the bezier curves is shown in FIGS. 6A and 6B. In FIG. 6A, a typical portion of the character is shown defined by a quadratic bezier curve. In FIG. 6B, this quadratic bezier curve can be subdivided into the cubic bezier curve and a formula for drawing a cubic bezier curve is as follows:
x=x₀(1−t)³+3x₁t(1−t)²+3x₂t)²(1−t)+3x₃t³
y=y₀(1−t)³+3y₁t(1−t)²+3y₂t²(1−t)+y₃t³

One the cubic bezier curve points are known, a formula exists for rotating the X, Y and Z points to the new orientation as defined by the users control within a 3-dimensional space. A suitable rotation formula is provided below;

$${R}_{x} ( θ ) = [ \begin{matrix}1 & 0 & 0 & 0 \\ 0 & cos ( θ ) & - sin ( θ ) & 0 \\ 0 & sin ( θ ) & cos ( θ ) & 0 \\ 0 & 0 & 0 & 1\end{matrix} ]$$

$${R}_{y} ( θ ) = [ \begin{matrix}cos ( θ ) & 0 & sin ( θ ) & 0 \\ 0 & 1 & 0 & 0 \\ - sin ( θ ) & 0 & cos ( θ ) & 0 \\ 0 & 0 & 0 & 1\end{matrix} ]$$

$${R}_{z} ( θ ) = [ \begin{matrix}cos ( θ ) & - sin ( θ ) & 0 & 0 \\ sin ( θ ) & cos ( θ ) & 1 & 0 \\ 0 & 0 & 0 & 0 \\ 0 & 0 & 0 & 1\end{matrix} ]$$

It will be appreciated that, information in the font file for a character, only contains X and Y points. Furthermore, this X and Y points are generally in relation to a reference point on or around the character itself. Once an entire publication is laid out, it will be understood that the X and Y points that define a position of the control points for each character can be put in terms of X and Y coordinates in respect of an entire page. Therefore, a character in the middle of the page is defined by the X and Y coordinates of the control points for the character itself to assist in the drawing as well as the X and Y coordinates to the reference point for that character in the page as a whole. All these control points do not include a Z component as they are intended for reproducing the curve on a flat publication. Therefore, once a publication is laid out in the normal manner on a computer screen, the X and Y coordinates are known and the Z coordinate can be taken to be zero. It is only when the page itself is rotated about a reference point in 3-dimensional space that the Z component changes and can be defined in terms of the relative position of any of the control points with respect to the point of rotation of the page.

To then translate all the rotated X, Y and Z points back to the 2-dimensional screen or display means to show the image of the rotated page in 3-dimensional space, a further formula can be utilized as follows:
ScreeinX=({cx)/(c−z})+HorRes/2
ScreenY=VertRes/2−({cy)/(c−z})

In this formula, HorRes and VertRes relate to the screen resolution of the PC. The component “c” in the formula relates to the camera distance from the centre of rotation. In effect, the camera distance relates to the apparent distance of the user from the publication in the 3-dimensional space and equates somewhat to the zoom function on existing computer programs. The “z” component is the position on the z axis from the reference point on or about the page.

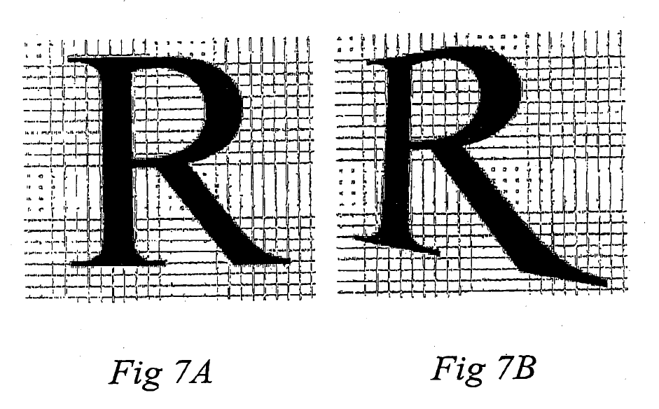

Referring to FIGS. 7A and 7B, a typical character is shown in FIG. 7A as it would be drawn directly from the existing font file. Once placed on a rotated plane, the same character is shown in FIG. 7B.

The preferred embodiment of this invention also seeks to smooth the lines on the character edges due to difficulties in redrawing scalable, re-orientated text on a typical display screen. When the character is relatively small, some pixelation of the character can be seen and this effect is made considerably worse once the character is rotated in the manner intended by this invention.

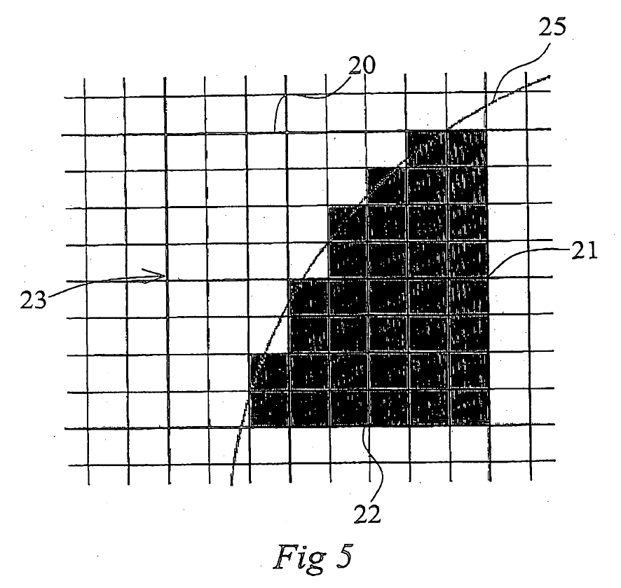

FIG. 5 provides an example of how a character edge may be smoothed. In the preferred form, each character is plotted to a larger scale grid map following rotation and translation back to the 2-dimensional screen. This step may be taken immediately prior to the actual drawing of the character on the screen. The rotated image is drawn to a large scale grid where, in FIG. 5, lines 20, 21, 22 and 23 correspond to a single pixel. In effect, the character is enlarged to be drawn on a grid 8 times larger in each direction.

Assume the line 25 is the actual path of the line of the character as it passes through the pixel defined by lines 20, 21, 22 and 23. Once drawn onto the larger size grid as shown in FIG. 5, a greater degree of precision can be obtained. Effectively, the precision is in the order of ⅛th of a pixel. As the line 25 is drawn on the larger grid, any square as shown in this 64 square grid which is within the character and, therefore, should be filled, and of which more than 50% is inside the character, is shown in a grey colour. If text is to be drawn to a precision of 64 shades of grey, a program to apply this 3D font-engine can simply account the grey squares as shown in FIG. 5 that define those squares more than half within the character and for each such square, the grey scale for the pixel may be increased by one. This will give an accurate pixel colour to the boundary of the character. In the case of transparent text whereby the background behind the text is supposed to be seen through the text, the actual calculated pixel value for the display screen may be created by blending the calculated pixel value as shown in FIG. 5 with the background pixel colour.

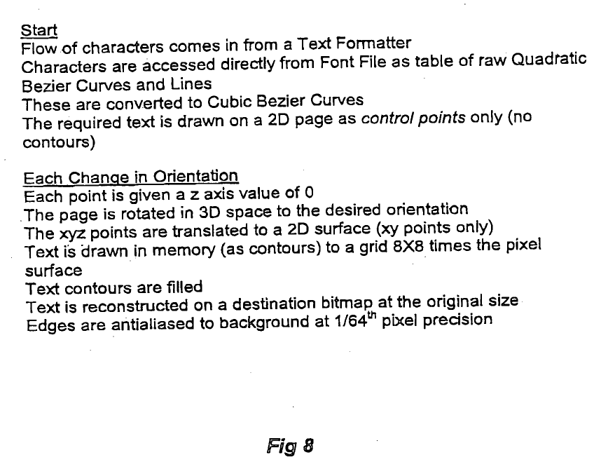

This smoothing of the characters improves the clarity of the characters despite their rotation on a 3-dimensional plane. Referring to FIG. 8, the general steps of a computer program to attend to these manipulations is shown.

At the start of the operation, character information is provided from a text formatter. The characters are exist directly from a font file as a table of raw quadratic bezier curves and lines. These are converted to cubic bezier curves and drawn on a 2-dimensional or flat page as control points only. There is no need to actually draw the lines but merely determine the X and Y coordinates where they can draw points in the page.

Upon the change of orientation of that page, the new position of all the control points is calculated. This commences with signing a Z axis value of zero to each of the character points and rotating them in 3-dimensional space with the formula provided previously. These are then translated back to the 2-dimensional surface having taken into account effective camera distance or distance of the user from the publication.

The text is drawn in memory to a grid 8 times larger than the pixel surface and the text contours are filled. The edges are then anti aliased and added to the background and the final image can be drawn to the screen.

Thus it can be seen that this 3-dimensional font-engine provides significant advantage over prior art solutions such as considering text as an image and simply rotating the entire image in 3-dimensions with the loss of information and clarity during the rotation process.

1. A method of producing an image on a display means corresponding to a font character rotated in a three dimensional environment comprising:
detecting a request from a user for the display of a character on at a particular orientation;
obtaining data on the character in terms of defining control points for the drawing of the character in a two dimensional environment;
rotating the defining control points to the orientation in three dimensional space; and
translating the points to the two dimensional environment of the display means and redrawing the character.

2. A method of producing an image on a display means corresponding to a font character rotated in a three dimensional environment as claimed in claim 1 wherein said defining character control points include Bezier curve control points for drawing the outline of the character.

3. A method of producing an image on a display means corresponding to a font character rotated in a three dimensional environment as claimed in claim 2 wherein said character is defined including quadratic Bezier control points for curves of the character in the data and these are sub-divided to points suitable for use with a cubic Bezier solution.

4. A method of producing an image on a display means corresponding to a font character rotated in a three dimensional environment as claimed in claim 1 wherein said character is redrawn to an enlarged grid in memory to determine the correct shade of pixels around at least a portion of the perimeter of the character.

5. A method of producing an image on a display means corresponding to a font character rotated in a three dimensional environment as claimed in claim 1 wherein a plurality of said font characters are provided in the form of a page of text and the image produced on the display means corresponds to the page of text rotated to a new orientation in a three dimensional environment.

6. A method of producing an image on a display means corresponding to a font character rotated in a three dimensional environment as claimed in claim 1 wherein said defining character control points are assigned an initial z axis value of zero when the data is supplied on the characters suitable for being drawn in a two dimensional environment and rotated with reference to a point of rotation to alter the z axis value if desired in the new orientation.

7. A method of displaying a page to text on a display means at a new orientation corresponding to movement of the page of text in a three dimensional environment comprising the steps of:
laying out the text in a two dimensional environment in terms of control points for the drawing of each character;
rotating all of the control points to the new orientation defined by the three dimensional environment; and
redrawing the text on the page at the new orientation.

8. A computer readable medium encoded with a computer program to provide a A method of producing an image on a display means corresponding to a font character rotated in a three dimensional environment comprising:
detecting a request from a user for the display of a character on at a particular orientation;
obtaining data on the character in terms of defining control points for the drawing of the character in a two dimensional environment;
rotating the defining control points to the orientation in three dimensional space; and
translating the points to the two dimensional environment of the display means and redrawing the character.

9. A computer readable medium encoded with a computer program to provide a method of displaying a page to text on a display means at a new orientation corresponding to movement of the page of text in a three dimensional environment comprising the steps of:
laying out the text in a two dimensional environment in terms of control points for the drawing of each character,
rotating all of the control points to the new orientation defined by the three dimensional environment; and
redrawing the text on the page at the new orientation.
